(19) United States
(12) Patent Application Publication
(10) Pub. No.: US 2016/0128289 A1
(43) Pub. Date: May 12, 2016

(54) HYDROPONIC SYSTEM WITH ACTUATED ABOVE-PLANT PLATFORM

(71) Applicant: Aessense Technology Hong Kong Limited, Harbour City (HK)

(72) Inventors: Simon Wong, Los Altos, CA (US); Wenpeng Hsueh, San Ramon, CA (US); Tianshu Chen, Dublin, CA (US); Guohua Lu, Shanghai (CN); Pei Kang, Shanghai (CN); Chao-Hsien Wu, Taoyuan (TW)

(21) Appl. No.: 14/937,789

(22) Filed: Nov. 10, 2015

Related U.S. Application Data
(60) Provisional application No. 62/078,315, filed on Nov. 11, 2014.

(51) Int. Cl. A01G 31/02; G05B 19/04

(52) U.S. Cl. CPC A01G 31/02; G05B 19/041; A01G 2031/006

(57) ABSTRACT

A hydroponic growth system may be integrated into a programmable system providing for the growth of plants. An upper section of a system may include a lighting system able to vary lighting characteristics such as the intensity or spectral content of light provided to the plants and atmospheric systems to control the temperature, flow, or humidity of air around the plants that are mounted on an actuated platform. A control system may execute a program to control the available systems including the actuated above-plant platform to programmably control the height or heights of the systems above plants.

### CROSS-REFERENCE TO RELATED APPLICATIONS

This patent document claims benefit of the earlier filing date of U.S. provisional Pat. App. No. 62/078,315, filed Nov. 11, 2014, which is hereby incorporated by reference in its entirety.

### BACKGROUND

Hydroponics allows growing of plants using nutrient aqueous solutions without soil, and aeroponics is a type of hydroponics that provides nutrient solutions in an aerosol of droplets that may be sprayed on or applied to plant roots. Hydroponic systems have been developed that include systems for delivery of nutrient-rich water to one or more plants. Such systems may be used outdoors, in a green house, or within a facility that provides a controlled environment for plant growth. In many applications, the hydroponic systems and the facility containing the hydroponic systems may be designed for the growth of a specific crop or plant. A particular system may, for example, be sized for a particular plant and may provide that type of plant with a nutrient solution chosen according to the plant's needs. A facility may provide a climate with a temperature and humidity suited for that plant and lighting with an intensity, a variation, or a duration also suited for growing that plant. Such hydroponic systems may provide poor performance for growing other types of plants.

### SUMMARY

In accordance with an aspect of the invention, an actuated above-plant platform of a hydroponic, or more particularly an aeroponic system, may provide multiple systems such as lights, exhaust fans, heater, and humidifiers. A programmable control system can operate the platform and raise or lower systems mounted on the platform for operation that is efficient for or adapted to the plants being grown and the current stage of the plants' growth. For example, the height of the platform may be initially set according to a type of plant being grown or a plant's current height or stage of development, and a control system may be programmed to change the height of the platform or operating parameters of the above-plant platform systems as the plant grows or ages.

### BRIEF DESCRIPTION OF THE DRAWINGS

FIG. 1 illustrates an embodiment of a hydroponic or aeroponic system employing wireless communications.

FIG. 2 illustrates an embodiment of an integrated hydroponic or aeroponic system having an actuated above-plant platform.

FIG. 3 is a block diagram of one embodiment of lower aetrium electronics.

FIG. 4 is a side view of one embodiment of actuation mechanics for an above-plant platform.

The drawings illustrate examples for the purpose of explanation and are not of the invention itself. Use of the same reference symbols in different figures indicates similar or identical items.

### DETAILED DESCRIPTION

A hydroponic growth system may be integrated into a programmable system sometimes referred to herein as an aetrium, which may be connected, wirelessly or otherwise, to other hydroponic growth systems in a network. Each aetrium may integrates systems for providing a gamut of needs for growth of plants. An aetrium may, for example, include: a nutrient system able to select a mixture of nutrients; a dispenser or a mister able to select a method of applying the solution containing the nutrients to one or more plants; a lighting system able to vary lighting characteristics such as the intensity or spectral content light provided to the plants; and an atmospheric system to control the temperature, flow, or humidity of air around the plants; a sensing system to monitor characteristics of the plants, the nutrients, the lighting, or the atmosphere; and a control system that may execute a program to control and co-ordinate the available systems. An aetrium may further include an actuated above-plant platform on which one or more of the systems that provide the needs of plant growth are mounted, and the above-plant platform may be actuated to control the height or heights of the systems above plants.

PCT App. No. PCT/US15/042116, filed Jul. 24, 2015 and entitled “Plant Growth System with Wireless Control,” which is hereby incorporated by reference in its entirety, describes a plant growth system that is programmable to grow a wide variety of plants and may thus increase the flexibility and utility of hydroponics.

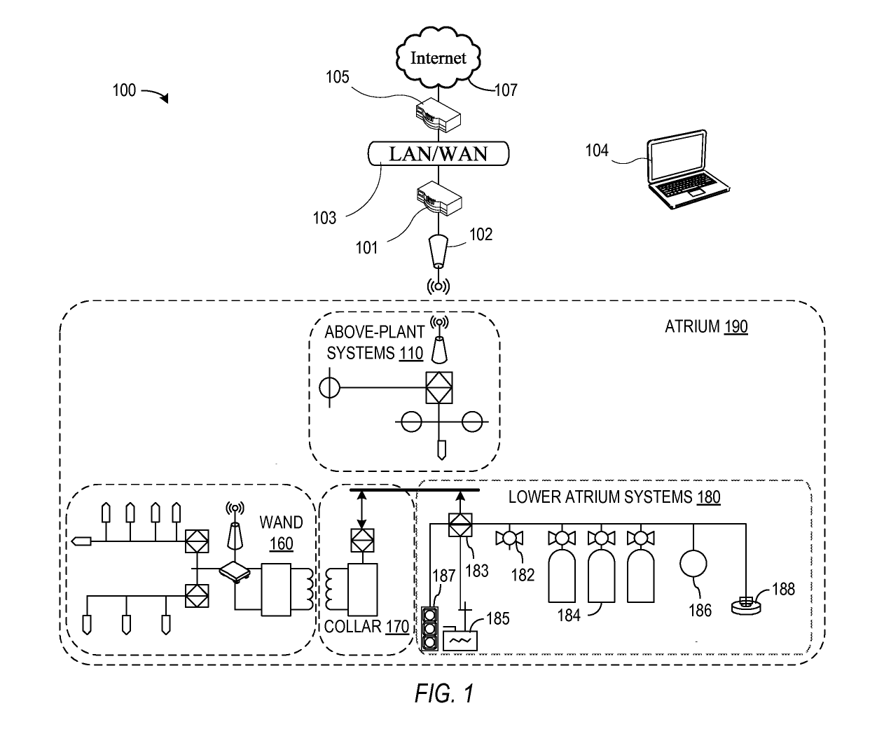

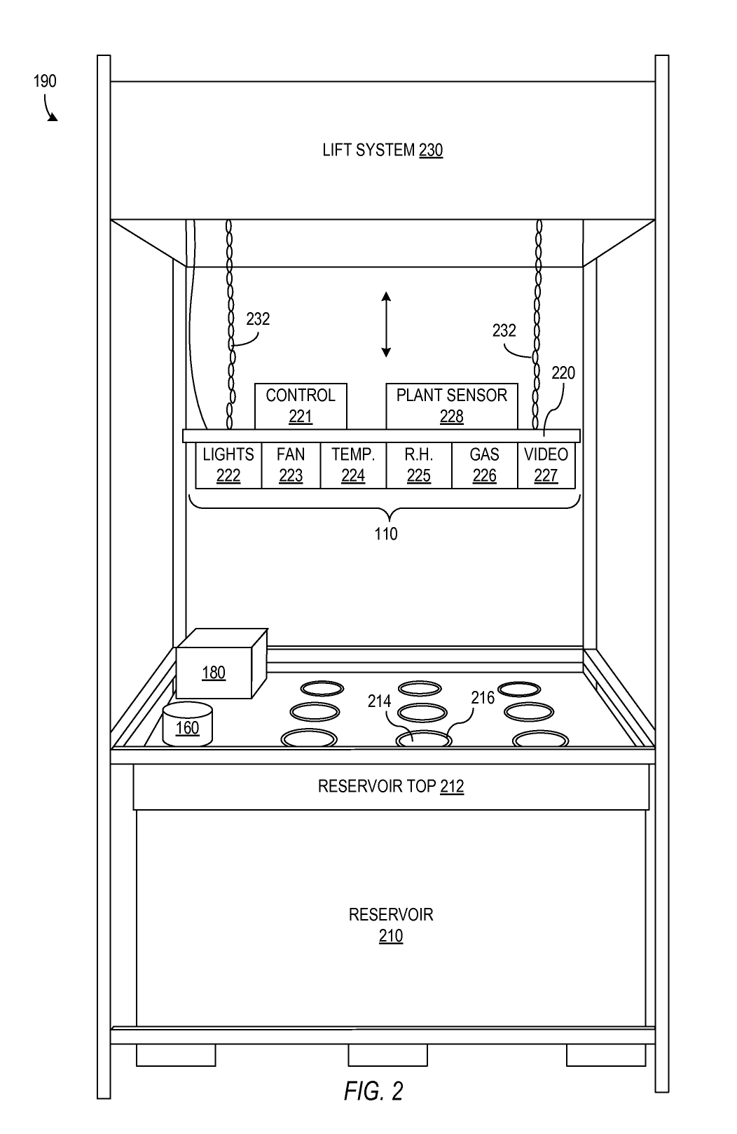

FIG. 1 shows a hydroponic growth system 100 including one or more aetriums 190. Each aetrium 190 generally includes electronic and mechanical systems packaged in an enclosure with a lower section and an upper section. For example, the lower section of aetrium 190 may include a reservoir 210 having a top 212 containing one or more plant fixtures 214 as shown in FIG. 2. Each plant fixtures 214 provides a structure capable of holding a plant during growth and may, for example, be a basket-type device through which the roots of the plant extend down towards the bottom of reservoir 210. Reservoir 210 may contain water or an aqueous nutrient solution. In some hydroponic applications, reservoir 210 contains the aqueous nutrient solution at a level that at least partially submerges the roots of plants in fixtures 214. In an aeroponic application, reservoir 210 may contain a low level of water or solution but provides an enclosed volume for the roots to occupy. For example, reservoir 210 may contain a level of nutrient solution below the deepest roots of the plants, may supply the nutrient solution to misters 216 that apply droplets of nutrient solution to the plants' roots, and may catch drops of solution that fall from the plants' roots or from misters 216. U.S. patent application Ser. No. 14/339,015, filed Jul. 23, 2014 and entitled “Apparatus for Providing Water and Optionally Nutrients to Roots of a Plant and Method of Using,” describes embodiments of misters such as misters 216 and is hereby incorporated by reference in its entirety.

The lower section may further contain a removable or interchangeable wireless sensor system 160, sometimes referred to herein as the Water, Air, Network Device or WAND 160, that receives power from and communicates through a collar 170 in the lower section. Various canisters, pumps, and other systems 180 for storing and mixing nutrients for growing plants according to an aeroponic methodology may also be mounted in the lower section of aetrium 190.

An above-plant systems 110 may include systems such as lighting equipment, a wireless communications device, a temperature sensor, a fire detector, a fan, and input terminals for main power. As shown in FIG. 2, some or all of above-plant systems 110 may be in the upper section of aetrium 190, and some or all may be mounted on an actuated platform 220 that is normally above plants that may be rooted in the lower section. The height of platform 220 above plants may be programmable. For example, platform 220 may be suspended from chains, cables, ropes, or other mechanical structures 232 attached to a lift system 230 capable of raising or lowering platform 220. Lift system 230 may, for example, include a winch in which structures 232 wind around a rotating drum, turned by a crank, motor, or other power source.

Lift system 230 and above-plant systems 110 on actuated platform 220 are among the components of the upper section of aetrium 190 and may be automated and controlled in conjunction with subsystems in the lower section of aetrium 190. For example, FIG. 1 shows a control device 104, such as a remote computing system, e.g., a desktop computer, a laptop computer, a tablet, or a smart phone, that controls one or more aetriums 190 through a public or private network, e.g., the Internet, a wide area network (WAN) or a local area network (LAN).

In the system of FIG. 1, some number of access points 102 that are able to communicate with aetrium 190 are connected to a router 101 of a LAN/WAN 103. LAN/WAN 103 may, for example, be a wireless network, a wired network, or a mixture of the two. In one implementation, LAN/WAN 103 is a Wi-Fi compliant network and one or more aetriums 190 are nodes on the network. Control device 104, which may be any sort of computing device with appropriate hardware or software, may connect to LAN/WAN 103 and communicate with each aetrium 190 on network 103, for example, to control lift system 230 and other subsystems 110, 160, and 180 in the upper and lower sections of aetrium 190. LAN/WAN 103 may further connect to the Internet 107 through a gateway or another router that may provide firewall protection 105. Accordingly, control device 104 may alternatively communicate with aetrium 190 through the Internet 107. In some embodiments, additional computing devices, some, all or none of which may be utilized at a given installation, may replace or be used with control device 104. Examples of such devices include a tablet, a smart phone, a camera, and a roving sensor that may be used within the installation, e.g., to identify or monitor installed aetriums 190.

Each aetrium 190 may be contained in a single enclosure such as shown in FIG. 2, and in a system with multiple aetriums, each aetrium 190 may be marked in some fashion, e.g., with a quick response (QR) code or other barcode placed where a tablet, smart phone, camera, or other portable device may read the code and report the identity of the aetrium 190, e.g., to control device 104. An electronic serial number (ESN) that matches the information provided by the QR code may be provided in the collar 170 and make a logical association between an aetrium 190 and the WAND 160 currently installed in the aetrium 190. A QR code emblem and ESN in the above-plant systems 110 or the upper section of aetrium 190 may be used in the same manner to identify or distinguish the type, model, or specific upper section available or currently in use in the aetrium 190.

In some implementations, WAND 160 may include air sensors for CO₂, CO, and O₂, and a light sensor. WAND 160 may also include a water sensor or sensors for sensing characteristics such as the pH, temperature, total dissolved solids (TDS), or resistivity of nutrient solution in reservoir 210. WAND 160 may be devoid of internal power and instead when inserted into collar 170 operates on power induced in the WAND 160 via proximate coils in WAND 160 and collar 170 when AC power is applied to the coil in collar 170. Such an arrangement allows WAND 160 to be easily removable. Removal of WAND 160 may be useful for easy replacement of a failed WAND or for changing the sensor complement installed in aetrium 190. The inductive connection may also reduce risks of electrical shorts in a wet environment that may be associated with reservoir 210 if electrical contacts or plugs are used.

WAND 160 may be configured with wireless communications capability, thereby acting as a gateway for subsystems such as systems 180 in the lower section of aetrium 190. Wired communications may be sealed within a subsystem and may be communicated by inductively communicating between the WAND 160 and the collar 170, which in turn connects to other devices within lower aetrium systems 180. Further details regarding systems suitable for WAND 160 and collar 170 are described in U.S. patent application Ser. No. 14/341,774, filed Jul. 26, 2014 and entitled “Portable Wireless Sensor System,” which is hereby incorporated by reference in its entirety.

Lower aetrium systems 180 in the embodiment of FIG. 1 provides a nutrient system that includes: a valve 182 to a water source; canisters 184 for dispensing nutrients, a pump 186 for mixing nutrient solution and priming nutrient carrying systems, and mister system 188 including misters 216 (FIG. 2) and associated pumps that draw from the mixed nutrient solution in reservoir 210. The palette of nutrients canisters 184 may include separate canisters for compounds providing phosphate, fixed nitrogen, potassium, acid to decrease pH, and base to increase pH to name a few. Other combinations are possible. Lower aetrium systems 180 in the implementation of FIG. 1 may further electronics including a controller 183 to control operation of at least the nutrient system of aetrium 190, a communication interface 185 for communications with controller 183, and a status/warning light 187 to provide a visible indication of the status of the nutrient system or aetrium 190 as a whole.

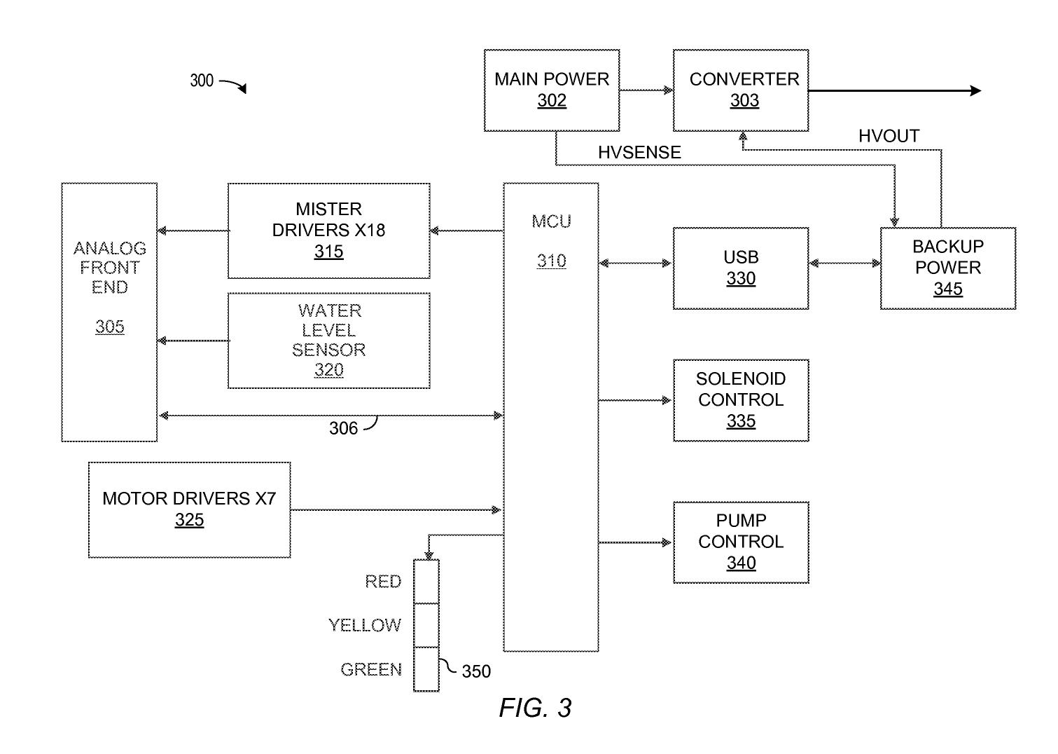

FIG. 3 shows a block diagram of one implementation of lower aetrium electronics 300. In the illustrated embodiment, a master control unit (MCU) 310 manages sensors and drivers in order to control the hardware systems within the lower section of aetrium 190. In FIG. 3, main power 302 is the power input to an aetrium 190 from the facility containing the aetrium 190. Main power 302 provides high voltage, for example, 120 VAC, which a converter 303 may convert to a lower voltage, e.g., to a 24 VDC. The 24 VDC converter 303 provides operating power to the downstream devices such as pumps. A backup power system 345, e.g., a backup battery, may sense the output of main power 302, and under certain conditions, for example, power failure, may take over providing 120 VAC to converter 303 or the 24 VDC to power electronics 300 until either main power 302 is restored or backup power 345 fails. Backup power system 345 provides a safety backup similar to those used in data centers configured to be failure resistant, and may allow MCU 310 to execute a routine to inform a control unit of the status of the aetrium and to operate aetrium 190 to maintain the health of plants growing in aetrium 190. In particular, backup power system 345 may communicate with MCU 310 via a USB 330, providing data as to the status of main power 302 and backup power 345, and MCU 310 may execute a specific program adapted according to the status of main power 302 and backup power 345.

A primary function of lower aetrium electronics 300 is to control the nutrient systems that provide the appropriate nutrients to plant roots. In an areoponic implementation, misters 216 provide a mist to plant roots, and each mister 216 has two small reservoirs and two transducers to generate the mist. Mister drivers 315 may provide control signals to the transducers to allow MCU 310 to control operation of misters 216, e.g., to control the quantity or characteristics of the mist. Signals from mister drivers 315 may be provided to an analog front end 305, wherein the signals are converted to digital data representative of the analog signals and the digital data is provided to the MCU 310 on a bus 306. MCU 310 can use the data to determine if any transducer has gone bad or any reservoir has gone dry, causing a transducer to shut down.

A motor driver 325 includes outputs for driving pumps, for example, peristaltic pumps. For backup, two small reservoirs of a mister may be refilled by two different pumps so that if one pump or side of a mister 216 (or a set of misters 216) fails, the other pump will likely still be operable so that the mister 216 (or set of misters 216) remains functional. Other motor driver 325 output signals may control individual canister pumps wherein each canister, e.g., canisters 184 of FIG. 1, contains a liquid or gel nutrient to be mixed into the solution in reservoir 210. For example, in one embodiment, the five canister pumps may be assigned to canisters holding a phosphate, a fixed nitrogen fertilizer, a potassium compound, an acid to decrease pH, and a base to raise the pH.

A water level sensor 320, for example, an eTape Water Level Sensor, provides a signal voltage that varies with how much water or solution in reservoir 210 covers the sensor 320. The water level sensed is in the main water reservoir 210 in the lower section of the aetrium 190. A solenoid controller 335 controls a valve for adding water 245 and another valve for priming a drain tube.

A status light system 350 may provide different color lights which MCU 310 may turn on or off to identify status or problems with the aetrium. For example, light 350 may signal: a green condition as good; a yellow condition warning that the aetrium is useable but attention is required, e.g., to a low water or canister level; or a red condition warning that aetrium 190 is an out-of-service condition such as failure of the mister pumps.

Above-plant systems 110 of FIGS. 1 and 2 are in the upper section of aetrium 190 and may perform several functions that are controllable wirelessly. Above-plant systems 110 may, for example, include relays or other circuitry that a control system 221 operates locally to control operation of a lighting system 222, a ventilation system 223, a temperature control system 224, a humidity control system 225, a gas composition control system 226, and a video system 227 as shown in FIG. 2. Lighting system 222 may use any lighting technology, e.g., incandescent, fluorescent, LED, or gas discharge bulbs, for providing light of a desired intensity and spectrum to plants in fixtures 214. Ventilation system 223 may include one or more fans and vents operable to control an air flow around plants in fixtures 214 and may be coupled to system 224, 225, or 226 so that the air flow has a desired temperature, humidity, and composition. Temperature control system 224 may include a thermostat for measuring a temperature around the plants in fixtures 215 and a heater or other system for altering the temperature. Humidity control system 225 may similarly employ sensors for measuring relative humidity of air around plants in fixtures 214 and a drier or humidifier for altering the humidity of the air. Gas composition control system 226 may also include sensors to measures gas composition, particularly carbon dioxide concentrations, around plants in fixtures 214 and one or more gas canisters, e.g., a CO₂ cartridge, that may be used introduce gas components to control the composition of air around plants in fixtures 214. For implementations of aetrium 190 in which an atmospheric control system such as system 224, 225, or 226 is provided, the space in which plants grow may be enclosed, e.g., with vinyl or clear plastic sheeting, to limit loss of gas added in aetrium 190 for plant growth. Alternatively, aetrium 190 may be used in an enclosed environment or room that similarly restricts loss of added gases. Video system 227 may be used to monitor the growth of plants and for security purposes to monitor activity around aetrium 190, and may provide a real-time video feed to remote stations via the network connection of aetrium 190. Above-plant systems 110 may further include other systems that may be convenient to locate above growing plants.

Control system 221 may control the operation of systems 223 to 227 and further control operation of lift system 230 to control the height of platform 220 above the plants, for example, on which all or portions of above-plant systems 223 to 227 may be mounted. In one implementation, control system 221 includes a two-way wireless device, for example, a Wi-Fi transceiver, that allows control system 221 to communicate with a control device, such as control device 104 of FIG. 1. Accordingly, a remote control device or control system 221 may execute a program that controls the operation of above-plant systems 110 and platform 220. For example, a library of programs, e.g., applications, scripts, or routines may be provided, e.g., through the Internet or storage local to a facility or aetrium, where each program may correspond to a different type of plant and may be executed in a facility or aetrium for grow the corresponding plant. In one implementation, when aetrium 190 is used to grow a particular plant, a program corresponding to that plant type may be loaded for execution, e.g., by control device 104 (FIG. 1), control system 221 (FIG. 2) in the upper section of an aetrium 190, MCU 310 (FIG. 3) in the lower section of the aetrium 190, or some combination of such processors. A selected program may thus control many aspects of plant growth such as the nutrient mixture, the manner in which nutrient solution is applied to plants in the lower section of aetrium 190 including reservoir 210, the intensity and height of illumination of the plants, and the temperature and humidity of air around the plants. The selected program may particularly control above-plant systems 110 and lift system 230 to control lighting, air flow, local temperature, humidity, and gas composition around the plants and the height at which the lighting, air flow, heating or cooling, humidifiers, and gas components are applied. The program may further sense the parameters of aetrium 190 and the characteristics of the plants in fixtures 214 to vary all of the above factors according to size, age, health, or stage of growth of the plants.

One specific process that control system 221 may execute uses a sensor 228 to monitor or measure plants in fixtures 214, e.g., measure a distance to the tops of the plants or measure a height of the plants, and then automatically adjusts the height of platform 220 to vertically optimize the performance of above-plant systems 223 to 227. Sensor 228 may be part of one of systems 222 to 227 and in particular may employ a camera or other imaging or video system to detect the height of a plant relative to platform 220 or another portion of aetrium 190. In general, portions of above-plant systems 223 to 227 such as sensors, fans, lights, heaters, humidifies, and CO₂ supplies may operate most efficiently if located close to the plants. Actuation of platform 220 allows automated adjustment of the height of the above-plant systems to maintain efficiency throughout plant growth. In contrast, conventional hydroponic systems with fixed above-plant systems may need to provide space to accommodate the expected maximum height of mature plants, so that above-plant systems used in hydroponics may not be optimally placed for plant growth.

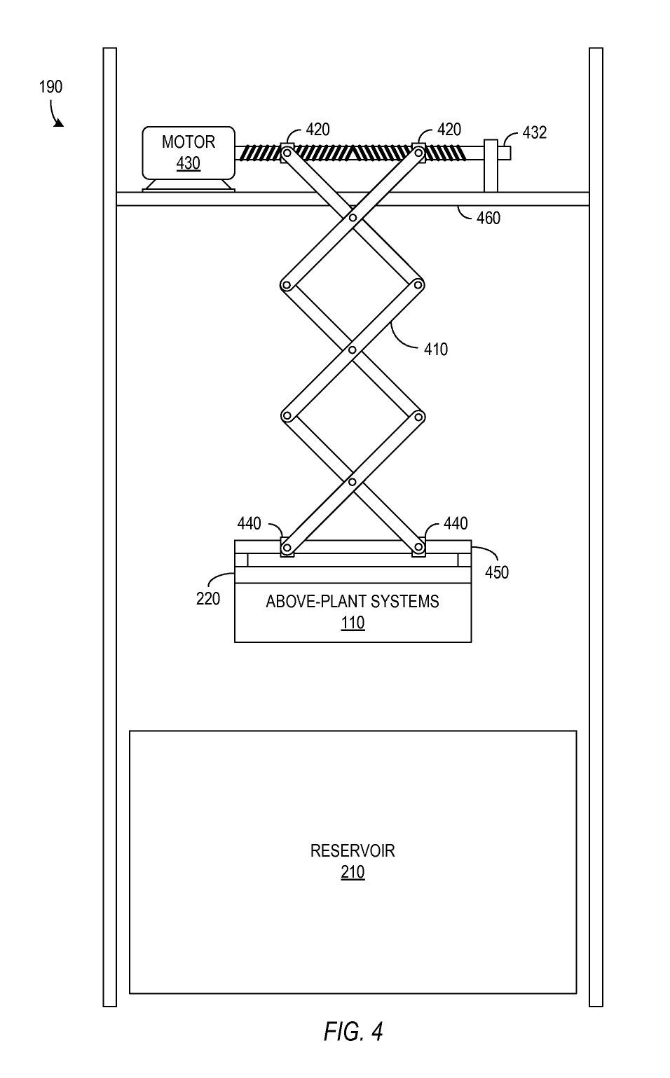

FIG. 4 shows a side view of one implementation of a hydroponic system or aetrium 190 having an actuated platform 220 on which above-plant systems 110 are mounted. In the illustrated configuration, a scissor lift 410 actuates platform 220. In particular, scissor lift 410 includes rigid structures hinged to form a series of crisscross “X” patterns, known as a pantograph (or scissor mechanism). In the illustrated configuration, the ends of the top “X” pattern are connected to nuts 420 on a leadscrew or thread shaft 432 of a motor or drive system 430. Bushings 440 connect bottom ends of the bottom “X” pattern to slide freely along a slide rail 450 on platform 220. Generally, two or more scissor mechanisms may connect platform 220 to upper support structure 460 of aetrium 190. In operation, turning shaft 432 in one direction increases the separation of nuts 420, which causes the connected series of “X” patterns to widen and shorten, thereby raising platform 220. Turning shaft 431 in the opposite direction decreases the separation of nuts 420, which causes the connected series of “X” patterns to narrow and lengthen, thereby lowering platform 220. Many different systems may power scissor lift 410. For example, the contraction or expansion of the scissor action can be hydraulic, pneumatic, or mechanical (via a leadscrew or rack and pinion system).

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A hydroponic system comprising:
an actuated platform;
an environmental control system mounted on the platform, wherein the environmental control system is configured to control an aspect of a local environment for a plant in the hydroponic system; and
a control system configured to execute a program that operates the actuated platform to vary a height at which the environmental control system operates.

2. The system of claim 1, wherein the system comprises an aeroponic system.

3. The system of claim 1, wherein the environmental control system comprises at least a portion of one or more of a lighting system, a ventilation system, a temperature control system, a humidity control system, a gas composition control system, and a video system.

4. The system of claim 1, wherein the control system is operable to select the program from a library of programs containing a plurality of programs respectively for growing of a plurality of different plants in the hydroponic system.

5. The system of claim 1, further the control system executes a process to measure a plant in the hydroponic system and to move the actuated platform to a position selected according to the measurement.

6. The system of claim 1, further comprising a sensor that measures a height of a plant in the hydroponic system or a distance to a top of the plant.

7. A process comprising:
growing a plant in a hydroponic system;
operating a sensor in the hydroponic system to measure the plant; and
operating an actuated platform on which an environmental control system above the plant to automatically change a distance between the environmental control system and the plant.

8. The process of claim 1, wherein the environmental control system comprises at least a portion of one or more of a lighting system, a ventilation system, a temperature control system, a humidity control system, a gas composition control system, and a video system.

9. A process comprising:
selecting a program for growing a plant in a hydroponic system;
executing the selected program to operate an actuated platform above the plant to automatically control a position of an environmental control system above the plant; and
operating the environmental control system according to the selected program to control an aspect of a local environment for a plant in the hydroponic system.

10. The process of claim 9, wherein selecting the program comprises selecting from among a plurality of programs respectively correspond to a plurality of plant types, the program that corresponds to a plant type of the plant growing in the hydroponic system.

11. The process of claim 9, wherein executing the selected program comprises measuring the plant, wherein operating the actuated platform is in response to a resulting measurement.
